(19) United States
(12) Patent Application Publication
(10) Pub. No.: US 2005/0097132 A1
(43) Pub. Date: May 5, 2005

(54) Hierarchical storage system

(75) Inventors: Robert Cochran, Roseville, CA (US); Jeffrey D. Ferreira-Pro, Folsom, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/697,821

(22) Filed: Oct. 29, 2003

(51) Int. Cl. G06F 17/00

(52) U.S. Cl. 707/104.1

(57) ABSTRACT

A storage system comprises a storage array containing an hierarchy of storage devices of at least three types and having a respective class hierarchy, and a controller. The controller is coupled to the storage device hierarchy and can execute an hierarchical storage management capability that selectively controls access to the hierarchy of storage devices.

### BACKGROUND OF THE INVENTION

Network storage arrays can use redundant data copies of data segments or entire records to perform useful data handling or processing functions and to ensure data availability. In one example, a storage system configuration can use multiple disks to store data. An application host creates new data that is written on a primary mirror disk. A disk controller responds to writes to the primary disk by updating the data changes to a secondary disk automatically. The secondary disk has read-only access from a backup and data mining host system, unless suspended. The mirrored pair has multiple states including an initial creation copy state with full out-of-order copying, a pair state with updated data sent, perhaps out-of-order, a suspended state with consistent and usable but stale data, and a resynchronize state in which data is inconsistent with out-of-order copying. Secondary data is only usable, consistent, and writeable during the suspended state.

With existing high-end disk array internal volume copy products, the time duration to transfer all primary volume data to reside on the secondary volume can be very long. At typical internal copy speeds of forty to eighty Megabytes per second, user volumes with a size in the range from hundreds to thousands of gigabytes can last several minutes. During the interim, substantial data loss can occur in the event of a disaster or catastrophe brought on by disturbances as common as a power loss or outage. Users are highly sensitive to the vulnerability inherent in the long copy times that exposes even the primary data to potential loss until the copy completes.

The highly vulnerable copy operation can be a common occurrence for purposes including data warehouse applications, data backup, application testing, and the like so that the loss potential is a frequent worry of users.

Virtual copy techniques exist that simulate or feign completion of the operation before the data has actually transferred. Such techniques utilize frantic out-of-order background copying if the user actually requests the data from the secondary volume. The known techniques have imperfections in that while the secondary volume reader is given the illusion of full data availability, failure of the primary volume prior to completion of a full copy leaves the secondary volume reader with inconsistent and unusable data.

Although additional storage for data handling is desirable, high-performance, highly-reliable storage is a large expense in high-capacity operations. Traditional disk arrays have two levels of hierarchical storage including volatile solid state cache and shared memory on one level, and non-volatile high-performance, high-priced (3-5 cents per megabyte) Small Computer Systems Interface or Fibre Channel (SCSI/FC) rotational storage. The high-priced rotational storage is generally allocated for high-quality enterprise usage, and considered too valuable for temporary or low frequency usage.

### SUMMARY

What is desired is a storage system and operating method that more efficiently and cost-effectively uses storage resources.

In various embodiments, a storage system comprises a storage array containing a plurality of storage devices of at least three types and having a respective class hierarchy, and a controller. The controller is coupled to the storage device hierarchy and can execute an hierarchical storage management capability that selectively controls access to the hierarchy of storage devices.

### BRIEF DESCRIPTION OF THE DRAWINGS

Embodiments of the invention relating to both structure and method of operation, may best be understood by referring to the following description and accompanying drawings.

FIG. 1 is a schematic block diagram that illustrates an embodiment of an hierarchical storage system.

FIG. 2 is a schematic block diagram depicting an example of a suitable storage array controller that can be used in an embodiment of an hierarchical storage system.

FIG. 3 is a schematic block diagram showing an example of a disk adapter that can be used for one of the levels of storage in the illustrative embodiment of the hierarchical storage system.

FIG. 4 is a schematic block diagram showing an example of a disk adapter that can be used for another of the levels of storage in the illustrative embodiment of the hierarchical storage system.

FIGS. 5A and 5B depict a schematic block diagram and a pictorial diagram showing an embodiment of a storage system.

FIG. 6 is a schematic block diagram illustrating an embodiment of a storage system that can execute a method for managing information storage.

FIG. 7 is a flow chart showing an embodiment of a method of managing information storage in a storage system.

### DETAILED DESCRIPTION

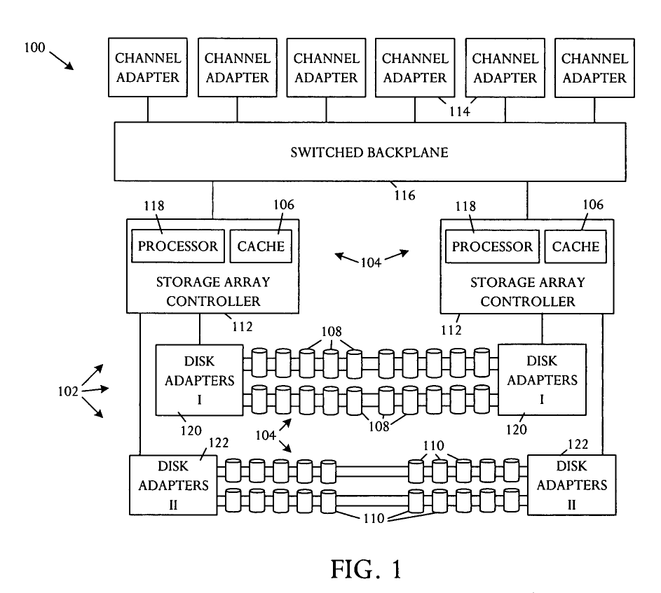

Referring to FIG. 1, a schematic block diagram depicts an embodiment of an hierarchical storage system 100. The storage system 100 comprises a storage array 102 containing a plurality of storage devices 104 of at least three types 106, 108, and 110 having a respective class hierarchy. The storage system 100 also comprises a controller 112. The controller 112 is coupled to the storage device hierarchy and is capable of executing an hierarchical storage management capability that selectively controls access to the hierarchy of storage devices 104.

In some embodiments, the storage array 102 contains an hierarchy of at least three types of storage devices 104 wherein the class hierarchy is a an hierarchy based on storage device performance. In other embodiments the class hierarchy is based on economic factors such as cost per unit of storage.

In an illustrative embodiment, the first storage device type 106 is a solid state cache and shared memory that supplies storage for a first level of hierarchical storage. The second storage device type 108 is composed of relatively higher performance Small Computer Systems Interface (SCSI) and/or Fibre Channel (FC) storage devices supplying storage for a second level of hierarchical storage. The third storage device type 110 is composed of relatively lower performance Serial AT-attached (SATA) storage devices supplying storage for a level of hierarchical storage. The controller 112 further comprises an executable process that allocates storage capacity of the SATA storage devices 110 to low access customer data and to short-term and unpredictable storage usage.

AT-attached devices (ATA), precursors to SATA drives, have conventionally been confined to the desktop market on the basis of cost and less-than-mission-critical application. Differentiators that separate ATA/SATA drives from Fibre Channel and SCSI competitors are speed and reliability. ATA and SATA drives usually operate at speeds sometimes substantially below 10,000 revolutions per minute (RPM), usually the low limit for SCSI drives. In terms of reliability, the mean time before failure (MTBF) for ATA/SATA desktop drives commonly is in a range of a few hundred thousand hours while SCSI drives are typically rated above one million hours. More recently, some SATA drives have improved reliability and operate at speeds between 5000 RPM and 7500 RPM at more than a million hours of operation.

In other embodiments, performance can be defined by parameters separate from or in addition to rotational disk revolution speed. For example the multiple levels of storage drives can be set to short stroke by limiting the number of accessible cylinders.

The illustrative storage system 100 includes both higher price and performance storage devices at one storage level 108 and a lower price and performance devices at another storage level 110.

In some embodiments, the controller 112 or another hierarchical storage management controller can be used within a storage array 102 that is a disk storage array utilizing Fibre Channel (FC) and SATA disk drives as the second level of storage 108 and that allocates SATA storage as the third storage level 110 as uncommitted and unstructured storage.

In some embodiments, the controller 112 or another hierarchical storage management controller can be used within a storage array 102 that is a disk storage array utilizing Fibre Channel (FC) and SATA disk drives as the second storage level 108 and that allocates SATA storage as the third storage level 110 for intra-array and/or inter-array data transfers including logical unit (LUN) copies and snapshots.

In some embodiments, the third level SATA storage 110 can be used for intermediate storage, for example as a temporary repository for data en route to eventual archiving on tape, as a destination for remote volume mirroring. Some applications may utilize target storing for copy services including a snapshot repository, a destination for remote volume mirroring, and electronic vaulting. The SATA storage 110 can also be used for tiered storage for applications with multiple variable performance, availability, and cost characteristics.

The illustrative hierarchical storage system 100 includes a plurality of channel adapters 114 that communicate with storage array controllers 112 via a switched backplane 116. The channel adapters 114 connect to a communication fabric, such as a storage array network (SAN) fabric, and receive data requests from servers and clients. A channel adapter 114 performs functions similar to operations of a host bus adapter that resides in a server including connecting to common networks such as Fibre Channel (FC) and Small Computer System Interfaces (SCSI) or internet SCSI (iSCSI) networks. Typically, multiple channel adapters 114 are used in a storage disk array based on the size of the network, amount of traffic conveyed, and utility of redundancy. The switched backplane 116 efficiently communicates requests from the channel adapters 114 to the storage array controllers 112 on redundant paths to ensure reliability.

In the illustrative system 100, the storage array controllers 112 include processors 118 configured with cache memories 106 that can form one level of the storage hierarchy. In some embodiments, the processors 118 are high-performance processors arranged in a configuration typical of servers. The caches 106 ensure data integrity and hide disk latency. The storage array controllers 112 communicate information between the backplane 116 and the multiple-level storage devices 104. More specifically, the storage array controllers 112 interface with disk adapters 120 and 122 that control the multiple-level physical storage devices 104.

The illustrative embodiment includes two levels of rotational storage including a relatively higher performance level of storage 108 such as Fibre Channel and/or Small Computer Systems Interface (SCSI) storage. The storage array controllers 112 connect to the relatively higher performance storage 108 via FC and/or SCSI disk adapters 120. The second level of rotational storage is a relatively lower performance level 110 such as Serial AT-Attached (SATA) storage. The storage array controllers 112 connect to the relatively lower performance storage 110 via SATA disk adapters 122. The disk adapters 120 and 122 control the respective storage arrays 108 and 110 to improve data availability and read/write performance. In an illustrative system 100, the disk adapter 120 can support either SCSI or Fibre Channel Arbitrated Loop (FC-AL) disk interfaces.

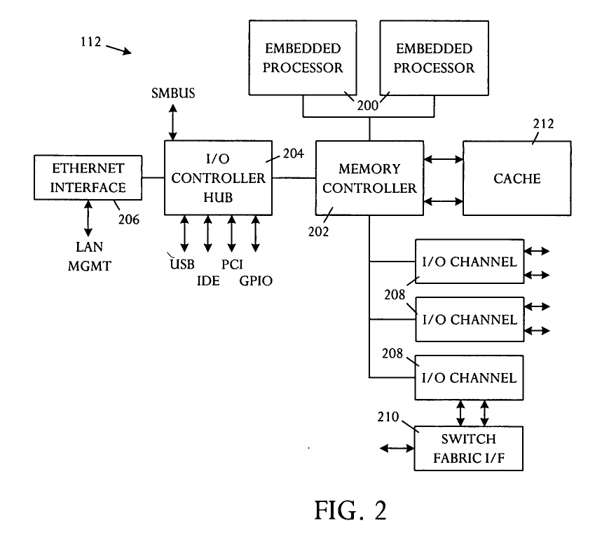

Referring to FIG. 2, a schematic block diagram depicts an example of a suitable storage array controller 112 that can be used in an embodiment of an hierarchical storage system 100. The storage array controller 112 can have multiple processors 200 with interfaces to the switched backplane 116 and input/output channel interfaces 208 to the disk adapters 120 and 122. The number of storage array controllers 112 scales to the number of storage devices in the arrays. Similarly, the number of interfaces within the storage array controllers 112 scales with the number of channel adapters 114.

The embedded processors 200 generally are high-performance processors that are capable of transferring information at a high rate to support multiple storage devices in a scaleable storage array controller. A memory controller 202 is connected to the embedded processors 200 and operates as a hub device to transfer data among a network fabric, and the multiple levels of storage 104. The illustrative memory controller 202 has multiple channels for communicating with a cache memory 212 to ensure sufficient bandwidth for data caching and program execution. The memory controller 202 has sufficient performance to manage the multiple I/O channels 208.

An Ethernet interface 206 communicates with the memory controller 202 via an input/output (I/O) controller hub 204 that includes an integrated Fast Ethernet Media Access Controller (MAC) to form a local area network (LAN) management interface port. The I/O controller hub 204 includes typical peripheral interfaces including Universal Serial Bus (USB), Peripheral Component Interconnect (PCI), Integrated Drive Electronics (IDE), General Purpose Input/Output (GPIO), System Management Bus (SMBus), and the like.

The number of channel adapters 114 that connect a storage array to a network fabric most appropriately relates to the size of the network. For example, a high-end storage disk array in a storage array network (SAN) configuration can utilize sixteen or more channel adapters 114. In specific embodiments, a channel adapter 114 can connect a PCI-X bus to a switch fabric interconnect device 210 and a controller such as a Gigabit Ethernet or Fibre Channel controller based upon the type of network fabric, iSCSI or Fibre Channel.

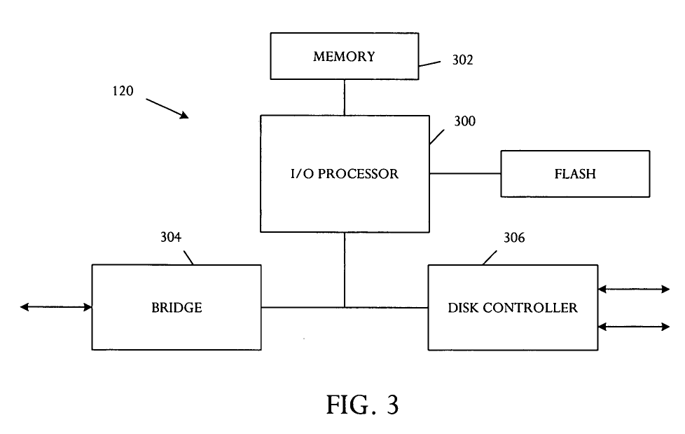

Referring to FIG. 3, a schematic block diagram shows an example of a disk adapter 120 that can be used for one of the levels of storage in the illustrative embodiment of the hierarchical storage system 100. The disk adapter 120 connects to the storage array controller 112 through a bus and controls access to the storage subsystem 108. In the illustrative embodiment, the storage subsystem can be based on a suitable technology, for example Fibre Channel-Arbitrated Link (FC-AL) and/or Ultra Small Computer Systems Interface (SCSI) technology. The disk adapter 120 includes an input/output processor 300 that controls operations of a disk controller 306, for example a dual channel PCI-X SCSI or Fibre Channel controller. The I/O processor 300 functions as a main controller and manages both adapters and buffers data, for example in memory 302. In various embodiments, the I/O processor 300 can perform some functions that otherwise can be executed in the storage array controllers 112, for example management of a Redundant Array of Independent Disks (RAID) software stack and the like. In various examples, the I/O processor 300 can interface to devices such as Fibre Channel (FC) controllers, SCSI controllers, PCI bridges, Gigabit Ethernet controllers, other PCI/PCI-X devices, and the like. The disk adapter 120 communicates with the storage array controller 112 via a bridge 304 that makes the connection via a bus, such as a PCI-X bus.

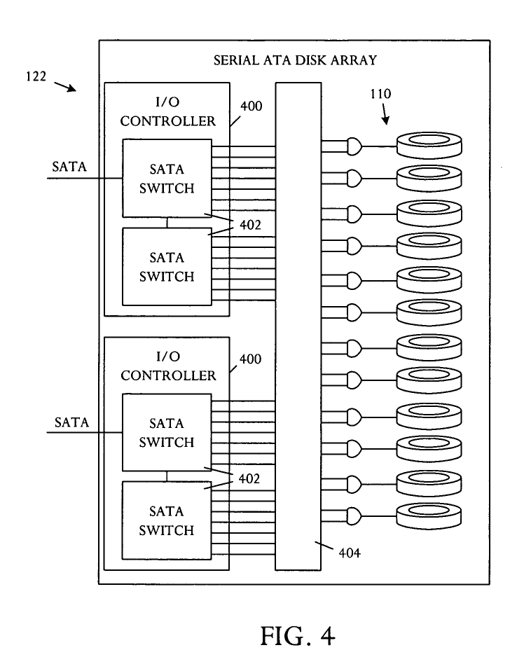

Referring to FIG. 4, a schematic block diagram shows an example of a disk adapter 122 that can be used for another of the levels of storage 110 in the illustrative embodiment of the hierarchical storage system. The disk controller 122 includes one or more input/output controllers 400, each having one or more Serial ATA switches 402. The SATA switches 402 communicate with the storage array 110 via a backplane 404. The SATA switches 402 can be used in disk arrays 122, for example in which embedded Network Attached Storage (NAS) heads and RAID controllers use multiple switches 402 to connect serial ATA drives over a high speed backplane 404.

In an illustrative embodiment, the SATA switches 402 can be a Serial ATA host bus adapter with multiple Serial ATA channels communicating data at high speed, for example 1.5 Gigabits/sec. The SATA switches 402 accept host commands through a bus, such as a PCI-X bus, process the commands, and transmit the processed commands to one of multiple serial ATA devices.

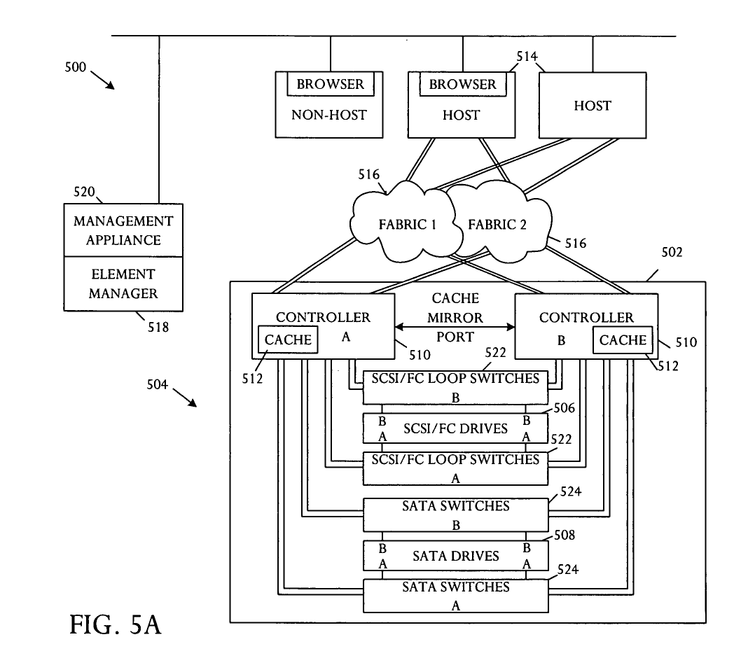

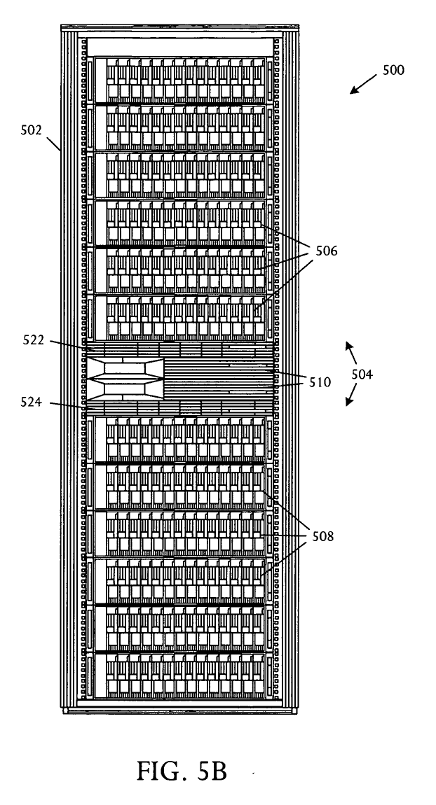

Referring to FIGS. 5A and 5B, a schematic block diagram and a pictorial diagram show an embodiment of a storage system 500 comprising a cabinet 502, a disk array 504 enclosed within the cabinet 502 and containing an hierarchy of storage disks of at least two types 506 and 508. The hierarchy of storage disks 506 and 508 has a respective class hierarchy. The storage system 500 further comprises a controller 510. The controller 510 is enclosed within the cabinet 502 and coupled to the disk array 504. The controller 510 can execute an hierarchical storage management capability that selectively controls access to the hierarchy of storage disks. Through virtualization techniques, a disk array 504 may be a virtual aggregation of several disparate disk arrays under a virtualization disk array controller and may or may not be confined within a physical cabinet 502. Therefore some embodiments may omit the cabinet 502.

The storage system 500 can further comprise a cache memory 512 coupled to the controller 510 and operable as an additional storage level in the class hierarchy. In some embodiments, the hierarchy of storage devices has a performance hierarchy. In other embodiments, the hierarchy is based on economics or cost.

The depicted storage system 500 includes two controllers 510 that are mutually connected to a storage drives 506 and 508, for example arrays of disk drives. The storage devices 506 and 508 communicate information including data and commands among many host systems 514 via one or more network fabrics 516. The depicted system includes an element manager 518, which resides on a management appliance 520, that also connects to the network fabrics 516. The disclosed technique for managing command ordering generally executes on one or more of the controllers 510, although some systems can possibly execute the technique in other processors or controllers, such as the element manager 518 or otherwise in the management appliance 520. The controller pair 510 connects to interface loop switches 522 for a first storage level, such as SCSI and or Fibre Channel (FC) switches, and switches 524 for a second storage level, such as SATA switches.

The particular embodiment includes relatively higher performance Small Computer Systems Interface (SCSI) and/or Fibre Channel (FC) disks supplying storage for a first level of hierarchical storage 506 and relatively lower performance Serial AT-attached (SATA) disks supplying storage for a second level of hierarchical storage 506. A process executable in the controller 510 allocates storage capacity of the SATA disks to low access customer data and to short-term and unpredictable storage usage.

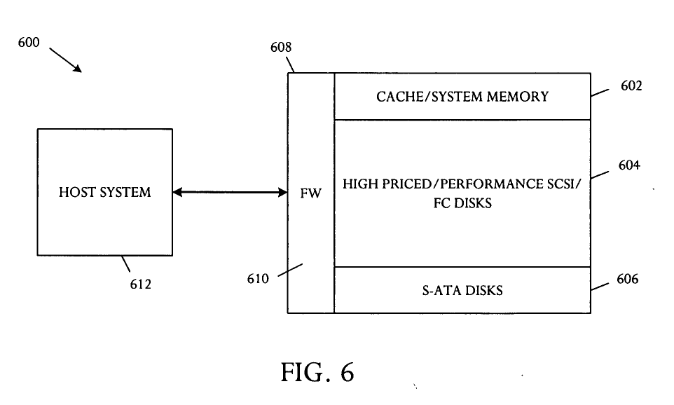

Referring to FIG. 6, a schematic block diagram illustrates an embodiment of a storage system 600 that can execute a method for managing information storage. The method involves coupling an hierarchy of storage devices of at least three types 602, 604, and 606 having a respective class hierarchy within a storage array 608. The method further comprises selectively controlling information access to the hierarchy of storage devices within the storage array 608. The storage system 600 has a disk array rotational storage hierarchy including an hierarchically inferior level of lower-price, for example in a range from approximately 1/3 to ⅕ the price of Fibre Channel disks, and/or lower performance Serial ATA (SATA) drives 606 which can be used for temporary/unexpected, although possibly mission-critical, storage, and/or hierarchical storage management (HSM)-type low usage user data storage.

In a particular embodiment, the storage system 600 includes a firmware-based 610 Hierarchical Storage Management (HSM) system within a disk array 608 utilizing both Fibre Channel (FC) 604 and SATA 606 disk drives. The array firmware 610 can reserve the SATA storage 606 for usage as uncommitted/unstructured storage in various applications. Information files that are infrequently used are tolerant of lower performance and may be appropriate for usage with the SATA storage 606. The SATA storage 606 can be used for temporary, although critical, uncommitted, non-volatile storage that may or may not be pre-allocated into specific logical units (LUNs). Particular applications that may use temporary storage include LUN mirror resynchronization, storage of a mirror volume shadow, snapshot liability migration, and storage overdraft protection.

The SATA storage 606 may also be used for intra-array storage, for example for storage of LUN snapshots and full LUN copies, and for inter-array temporary storage of LUN copies. The temporary SATA storage 606 can supply extra storage space while avoiding constraints imposed by LUN copy licenses, pre-assignment, or reconfiguration. Usage of the extra storage space generally is application or condition-dependent and can arise unexpectedly, imposing temporary and sometimes critical storage demands.

The hierarchical array 608 can be activated via commands from a host system 612, for example a host running a backup software application.

The higher performance drives 604, such as FC/SCSI, and lower performance drives 606, such as SATA drives, combine within the same array 608 with firmware 610 empowered to make available some SATA storage for low access customer data, for example for usage in firmware-based Hierarchical Storage Management (HSM), and to retain some SATA storage for critical short-term and unpredictable storage usage that is not appropriate for cache and shared-memory 602 or high-performance storage or storage for which no pre-allocated space is set aside.

In one example of an application that can utilize hierarchical storage, a storage system performs primary mirror shadowing using a storage array and a controller. The controller predefines a storage array volume as a primary volume that is subsequently paired with a secondary volume, and emulates a primary logical device and multiple secondary logical devices. The emulated secondary logical devices include a shadow logical device. The controller can track volumes and logical devices using a pointer, and instantaneously evoke a volume copy by a pointer exchange. The shadow logical device can be emulated using the SATA storage. The controller reserves a pool of logical devices for usage as a secondary volume for subsequent pairing to a predefined primary volume. SATA storage 606 can be used for the logical device pool.

In another example of an application that can utilize hierarchical storage, SATA storage 606 can be used to implement backup window overdraft protection. In some circumstances, a critical backup operation may be aborted when the backup window is exceeded, resulting in lost data and a possible inability to recover from a disaster event. In a typical backup operation, backup software begins a data backup with a pick list generated from resolving files to be backed up into constituent LUNs/Tracks/Sectors/ranges. The level of abstraction created by Logical Volume Manager (LVM) striping and expansions can cause logical objects or files to unexpectedly cross many logical units (LUNs) and even more physical disks. Because a file may be thinly striped across many LUNs, and use only a fraction of each LUN, Zero-Downtime Backup (ZDB) products create full copies or snapshots of every entire LUN involved, possibly engaging many times more space than required. A non-ZDB backup can engage the entire primary data set of disks. If time runs out in a non-ZDB condition, the backup is forfeited. Overdraft protection is appropriate, for example, in conditions or circumstances that a customer with no licensed LUN copy or snapshot functionality, or not currently being enabled for Zero Downtime Backup, is about to exceed the backup window, thus losing the entire backup. Usage of hierarchical storage, for example the SATA level 606 of hierarchical storage, enables overdraft protection to salvage of the endangered backup using temporary non-volatile storage of sufficient capacity.

The illustrative window overdraft protection technique defines and uses inter-LUN pick list snapshots to prevent backup forfeiture utilizing only a fraction of the snapshot or full copy space that is typically used. For example, if the non-ZDB backup window is likely to be exceeded, backup software can choose a demarcation point in the pick list, and instruct the array to create a new type of internal copy or snapshot, for example using temporary SATA storage 606, based on the inter-LUN pick list. The backup software can finish the backup by reading from the LUN-agnostic snapshot, instead of the primary disk, for the duration of the backup.

The SATA storage 606 makes available additional storage space, while avoiding constraints of LUN copy licenses, pre-assignment, or pre-configuration, in conditions that additional storage is desirable due to unexpected events.

The various functions, processes, methods, and operations performed or executed by the system can be implemented as programs that are executable on various types of processors, controllers, central processing units, microprocessors, digital signal processors, state machines, programmable logic arrays, and the like. The programs can be stored on any computer-readable medium for use by or in connection with any computer-related system or method. A computer-readable medium is an electronic, magnetic, optical, or other physical device or means that can contain or store a computer program for use by or in connection with a computer-related system, method, process, or procedure. Programs can be embodied in a computer-readable medium for use by or in connection with an instruction execution system, device, component, element, or apparatus, such as a system based on a computer or processor, or other system that can fetch instructions from an instruction memory or storage of any appropriate type. A computer-readable medium can be any structure, device, component, product, or other means that can store, communicate, propagate, or transport the program for use by or in connection with the instruction execution system, apparatus, or device.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

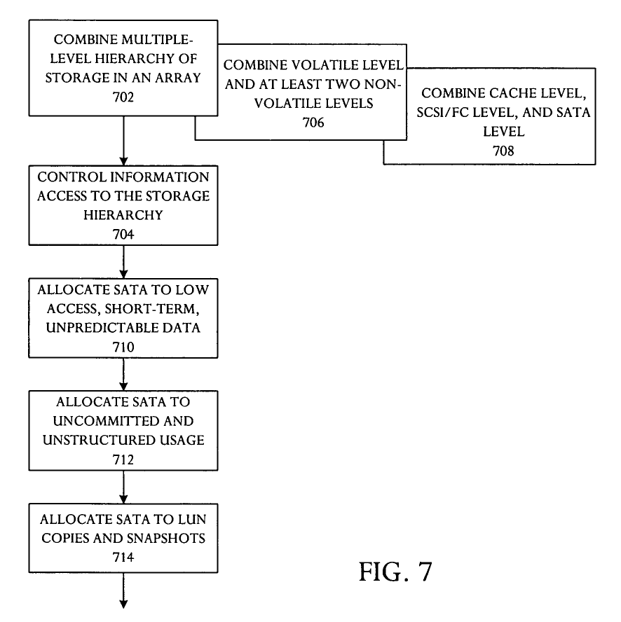

Referring to FIG. 7, a flow chart illustrates an embodiment of a method of managing information storage in a storage system 700 comprising enclosing an hierarchy of storage devices 702 of at least three types with a respective class hierarchy within a storage array, and selectively controlling information access to the hierarchy of storage devices within the storage array 704. In some applications and environments, the class hierarchy can be a performance hierarchy so that the different storage types have different levels of performance. In other applications and environments, the class hierarchy can be a cost or economic hierarchy so that different storage types have different costs. Some embodiments combine performance and economic bases for selection of the levels of hierarchy.

In a particular embodiment, the storage system combines an hierarchy of storage devices into the storage array including at least a volatile shared memory, a relatively higher performance non-volatile storage, and a relatively lower performance non-volatile storage 706.

In a more specific embodiment, the storage system combines an hierarchy of storage devices into the storage array including at least a solid state cache and shared memory supplying storage for a first level of hierarchical storage, relatively higher performance Small Computer Systems Interface (SCSI) and/or Fibre Channel (FC) storage devices supplying storage for a second level of hierarchical storage, and relatively lower performance Serial AT-attached (SATA) storage devices supplying storage for a level of hierarchical storage 708.

The method can include the action of allocating storage capacity of the SATA storage devices to low access customer data and to short-term and unpredictable storage usage 710.

In some applications and conditions, the method can include the action of allocating SATA storage as uncommitted and unstructured storage 712.

Some applications can include the action of allocating SATA storage for intra-array and/or inter-array data transfers including logical unit (LUN) copies and snapshots 714.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, the disclosed apparatus and technique can be used in any database configuration with any appropriate number of storage elements. Although, the database system discloses magnetic disk storage elements, any appropriate type of storage technology may be implemented. The system can be implemented with various operating systems and database systems. The control elements may be implemented as software or firmware on general purpose computer systems, workstations, servers, and the like, but may be otherwise implemented on special-purpose devices and embedded systems.

1. A storage system comprising:
a storage array containing a plurality of storage devices of at least three types and having a respective class hierarchy; and
a controller coupled to the storage device hierarchy and capable of executing an hierarchical storage management capability that selectively controls access to the hierarchy of storage devices.

2. The storage device according to claim 1 wherein:
the storage array contains an hierarchy of storage devices of at least three types and having a respective performance hierarchy.

3. The storage device according to claim 1 further comprising:
the storage array contains an hierarchy of storage devices of at least three types and having a respective economic or cost hierarchy.

4. The storage device according to claim 1 further comprising:
a solid state cache and shared memory supplying storage for a level of hierarchical storage.

5. The storage device according to claim 1 further comprising:
relatively higher performance Small Computer Systems Interface (SCSI) and/or Fibre Channel (FC) storage devices supplying storage for a level of hierarchical storage.

6. The storage device according to claim 1 further comprising:
relatively lower performance Serial AT-attached (SATA) storage devices supplying storage for a level of hierarchical storage.

7. The storage device according to claim 1 further comprising:
a solid state cache and shared memory supplying storage for a first level of hierarchical storage;
relatively higher performance Small Computer Systems Interface (SCSI) and/or Fibre Channel (FC) storage devices supplying storage for a second level of hierarchical storage;
relatively lower performance Serial AT-attached (SATA) storage devices supplying storage for a level of hierarchical storage; and
a process executable in the controller allocates storage capacity of the SATA storage devices to low access customer data and to short-term and unpredictable storage usage.

8. The storage device according to claim 7 further comprising:
an hierarchical storage management controller for usage within a disk array utilizing Fibre Channel (FC) and SATA disk drives and that allocates SATA storage as uncommitted and unstructured storage.

9. The storage device according to claim 7 further comprising:
an hierarchical storage management controller for usage within a disk array utilizing Fibre Channel (FC) and SATA disk drives and that allocates SATA storage for intra-array and/or inter-array data transfers including logical unit (LUN) copies and snapshots.

10. A method of managing information storage in a storage system comprising:
enclosing an hierarchy of storage devices of at least three types and having a respective class hierarchy within a storage array; and
selectively controlling information access to the hierarchy of storage devices within the storage array.

11. The method according to claim 10 further comprising:
coupling an hierarchy of storage devices into the storage array including at least three types having a respective performance hierarchy.

12. The method according to claim 10 further comprising:
coupling an hierarchy of storage devices into the storage array including at least three types having a respective economic or cost hierarchy.

13. The method according to claim 10 further comprising:
combining an hierarchy of storage devices into the storage array including at least a volatile shared memory, a relatively higher performance non-volatile storage, and a relatively lower performance non-volatile storage.

14. The method according to claim 10 further comprising:
combining an hierarchy of storage devices into the storage array including at least a solid state cache and shared memory supplying storage for a first level of hierarchical storage, relatively higher performance Small Computer Systems Interface (SCSI) and/or Fibre Channel (FC) storage devices supplying storage for a second level of hierarchical storage, and relatively lower performance Serial AT-attached (SATA) storage devices supplying storage for a level of hierarchical storage.

15. The method according to claim 14 further comprising:
allocating storage capacity of the SATA storage devices to low access customer data and to short-term and unpredictable storage usage.

16. The method according to claim 14 further comprising:
allocating SATA storage as uncommitted and unstructured storage.

17. The method according to claim 14 further comprising:
allocating SATA storage for intra-array and/or inter-array data transfers including logical unit (LUN) copies and snapshots.

18. A storage system comprising:
a disk array containing an hierarchy of storage disks of at least two types and having a respective class hierarchy; and
a controller coupled to the disk array and capable of executing an hierarchical storage management capability that selectively controls access to the hierarchy of storage disks.

19. The storage system according to claim 18 further comprising:
a cache memory coupled to the controller and operable as an additional storage in the class hierarchy.

20. The storage system according to claim 18 further comprising:
an hierarchy of storage devices having a respective performance hierarchy.

21. The storage system according to claim 18 further comprising:
an hierarchy of storage devices having a respective economic or cost hierarchy.

22. The storage system according to claim 18 further comprising:
a cabinet enclosing the disk array and the controller.

23. The storage system according to claim 18 further comprising:
relatively higher performance Small Computer Systems Interface (SCSI) and/or Fibre Channel (FC) disks supplying storage for a first level of hierarchical storage;
relatively lower performance Serial AT-attached (SATA) disks supplying storage for a level of hierarchical storage; and
a process executable in the controller allocates storage capacity of the SATA disks to low access customer data and to short-term and unpredictable storage usage.

24. An article of manufacture comprising:
a controller usable medium having a computable readable program code embodied therein for managing a storage system, the computable readable program code further comprising:
a code capable of causing the controller to intercommunicate among an hierarchy of storage devices of at least three types and having a respective class hierarchy within a storage array; and
a code capable of causing the controller to selectively control information access to the hierarchy of storage devices within the storage array.

25. A storage system comprising:
means for coupling an hierarchy of storage devices of at least three types and having a respective class hierarchy within a storage array; and
means for selectively controlling information access to the hierarchy of storage devices within the storage array.
